(19) United States
(12) Patent Application Publication
(10) Pub. No.: US 2002/0130446 A1
(43) Pub. Date: Sep. 19, 2002

(54) Outside bubble air cooling ring for blown plastic film

(76) Inventor: Robert D. Krycki, Brampton (CA)

Correspondence Address: Andrew S. McConnell, Boyle, Fredrickson, Newholm, Stein & Gratz, S.C., Suite 1030, 250 E. Wisconsin Avenue, Milwaukee, WI, 53202, US

(21) Appl. No.: 10/043,375

(22) Filed: Jan. 9, 2002

(30) Foreign Application Priority Data
Mar. 15, 2001 (CA) 2,340,812

(51) Int. Cl. B29C 47/88

(52) U.S. Cl. 264/563; 425/71; 425/378.1

(57) ABSTRACT

A novel air cooling ring is provided herein for supplying successive streams of cooling air to a surface of a tubular bubble of plastic, after its extrusion from an annular die surface, the annular die surface having a die axis. The air cooling ring includes a ring-shaped plenum chamber which is provided radially-outwardly of the die axis from annular die orifice. The ring shaped plenum chamber has an air inlet, and an air outlet. The ring-shaped plenum chamber also includes an upper lip, which includes such air inlet and the air outlet, and a lower deflector lip. A forming cone extends radially outwardly from the air cooling ring. An annular air passage, which is formed in the forming core, communicates with the air outlet in the ring-shaped plenum chamber. A plurality of axial outlet ports is provided in that annular air passage. An annular air chamber communicates with the plurality of axial outlet ports to direct cooling air downwardly and radially-outwardly to a lower annular air outlet, and then to divert the cooling air both in an upward direction between a surface of the forming cone and the tubular bubble of plastic and radially-and-horizontally-inwardly between the lower portion of the upper lip of the ring and the deflector lip.

### BACKGROUND OF THE INVENTION

(a) Field of the Invention

The present invention relates to the plastics industry in general and in particular to apparatus for extruding blown film. More particularly, it relates to an air cooling ring for supplying air to cool a plastic tubular bubble as it leaves an extrusion die.

(b) Description of the Prior Art

All blown film is extruded either vertically, up or down, or horizontally. In all instances, once the polymeric material exited the cylindrical die as a tube, it formed a tubular “bubble” and was drawn from the die by means of two rollers (usually known as “nip rollers”) which contacted a collapsed outer end of the bubble. As it exited the die, the bubble was created by inflation of the tube with air to the desired diameter. Normally, the air inflated the bubble through the die and, once the requisite diameter had been reached, inflation ceased and the air was trapped between the face of the die and the nip rollers.

As the bubble left the die, it was cooled by air which was blown from an annular nozzle or nozzles which were provided in an air cooling ring, or so-called “air ring”, which was connected to an air plenum chamber which supplied large quantities of air to the outside of the bubble so that it became firm before it contacted the nip rollers.

Hitherto, the angle of divergence at which the bubble expanded as it left the die orifice had been limited to less than about 30 degrees with respect to the die axis, and was usually about 20 degrees. Unless the bubble can continue to expand markedly after the bubble was clear of the cooling air, this limited the maximum diameter of the bubble.

A typical prior art such “air ring” was shown, for example, in U.S. Pat. No. 4,750,874, issued Jun. 14, 1998 to Keim, which showed an air ring having a first annular air outlet which was formed between a lower or inner lip and the adjacent end of an intermediate lip, and a second air outlet, downstream from the first outlet in the direction of travel of the bubble, which was formed between an upper or outer end of the intermediate lip and an outer lip. The inner and outer lips were arranged so that the bubble cannot expand at an angle of divergence of more than about 28 or about 30 degrees to the die axis as it left the die. It seemed to have been accepted in the industry that an angle of divergence of the bubble of more than about 30 degrees cannot be achieved.

Further to this, during operation of the apparatus to make blown film and for any given polymeric material, the blow up ratio and rate of change in film thickness of the tubular bubble were at least partly dependent upon the flow rate of cooling air which was directed onto the tubular bubble immediately after it left the die orifice. The blow up ratio was considered to be the ratio of the final expanded diameter of the tubular bubble to the tube diameter as it issued from the die orifice. To adjust these parameters, it may have been necessary to adjust the flow rate of cooling air through an annular nozzle which lay closely adjacent to the die orifice. Adjustment of the cooling air flow rate was known to be a fine tuning operation to produce required blow up ratios and film thicknesses which were suitable for a particular polymer. Conventionally, the adjustment required an operator to reach into the radially-central regions of the air cooling ring to make mechanical adjustments. This operation had to be done with extreme care and precision and was delicate to perform, thereby requiring utmost operator skill. The difficulties in skill required and time taken to make the adjustments were increased where a cooling ring included a plurality of axially-spaced nozzles. In such arrangements, the nozzle which required adjustment was the radially-inner or the innermost of these nozzles.

In addition, the tube of polymeric material, upon issue from an extrusion die orifice, was accompanied by undesirable contaminants, e.g., smoke, odourous fumes and other airborne contaminants resulting from the extrusion process. These contaminants served to increase pollution of the atmosphere immediately within the working environment adjacent to the extrusion apparatus and progressively passed into, and polluted, the surrounding atmosphere within a factory. Hence, such contaminants presented an uncomfortable and possibly unhealthy atmosphere in which to work.

An apparatus which was an improvement upon conventional construction was provided by the present inventor in copending U.S. patent application Ser. No. 09/751,241 filed Dec. 29, 2000.

According to that invention, an air ring means for supplying successive streams of cooling air to the exterior surface of a tubular bubble of plastic, after its extrusion from an annular die orifice, was similar to that of the '874 Patent described above in that it comprised a ring-shaped plenum chamber having an air inlet means, a primary annular air outlet arranged to be located around and closely adjacent to the die and communicating with the plenum chamber, a secondary annular air outlet which was located axially-downstream of the primary annular air outlet in the direction of travel of the bubble, and also communicating with the plenum chamber, the primary annular air outlet being formed between a inner lip and an edge of an intermediate lip adjacent the inner lip, and the secondary annular air outlet being formed between an outer lip and an adjacent edge of the intermediate lip. That invention differed from the above prior art in that the inner lip, the intermediate lip and the outer lip provided a clear space allowing the tubular bubble to expand from the die at an angle of divergence, measured from the die axis, of 60 degrees or more. The intermediate lip preferably had a substantially-conical inner surface which diverged from the inner lipat an angle to the die axis which was at least as great as the aforementioned angle of divergence. The cross-sectional area of the secondary annular air outlet was preferably several times greater than the cross-sectional area of the primary air outlet.

That invention also provided an air ring structure having a primary and secondary annular air outlets, which was provided with an air flow control which was rotatably adjustable in position around the die axis. The air flow control comprised a ported ring which had a plurality of ports for air flow passages which allowed for air flow from the plenum chamber to the primary annular air outlet. Rotational adjustment of the ported ring in a desired direction caused movement of the ports relative to the air flow passages so as appropriately to adjust the effective area for air flow through the passages and thus the rate of air flow from the primary annular air outlet. In this further aspect of that invention, adjustment controls were also provided to adjust the rotational position of the air flow control means, the adjustment controls being operably connected to the ported ring and being operationally accessible exteriorly of the air ring structure.

Constructions according to that invention discussed above enabled the rate of air flow to the primary annular air outlet to be easily adjusted during operation of the extruder die, i.e., while plastics material was being extruded to form a plastic tubular bubble which was being continuously fed towards the nip rollers. The rate of cooling, rate of reduction in film thickness during radial expansion of the bubble, and blow up ratio, were more easily controllable during extrusion and bubble forming than had been possible previously. The ease of control of the rate of cooling air flow enabled the primary and secondary cooling air outlets to be designed to allow the tubular bubble to expand from the die orifice at an angel of divergence from the die axis of at least 45 degrees and up to 60 degrees or more without detrimentally affecting the product during its formation.

According to that invention, the ported ring position may also control, if required, the flow of air to the secondary annular air outlet of the ring means. However, under normal circumstances control of the rate of air flow was only required for the primary annular air outlet.

According to that invention, it was convenient for the air flow control to be located radially-outwardly of the die axis from the flow passages which were provided for air flow to the primary annular air outlet. This enabled the adjustment controls to be disposed a maximum distance away from the extruder die and thus more accessible for manual operation of this is to be used. Alternatively, the adjustment controls may be operated by powered means, e.g., electric power under the control of an operator, or, for instance, as controlled from a feedback mechanism having a downstream sensor measuring the thickness of the wall of the finished tubular bubble.

According to that invention, the adjustment controls preferably comprised a driving gear engaged with a driven gear which is provided upon the ported ring, the driving gear being rotatably mounted about a fixed axis upon a driving shaft which extended to the exterior of a wall of the air flow control means for operating purposes.

According to that invention, it was also convenient for an indicator to be provided at the exterior end of the driving shaft to indicate, at any particular position of rotation shaft, the amount of effective areas for air flow through the air flow passages that was provided with the shaft in the corresponding rotational position.

That invention also provided an apparatus for extruding a tubular bubble of plastic comprising a plastics extruder having an annular die orifice surrounding a die axis. The apparatus included an air ring for supplying cooling air to the exterior surface of the tubular bubble of plastic after its extrusion from the die orifice. The air ring means included a ring shaped plenum chamber radially-outwardly of the die axis from the die orifice and having cooling air inlet means. An annular cooling air outlet was interconnected to the plenum chamber closely adjacent to the die orifice to cause the tubular bubble to expand radially in coaxial manner relative to the die axis as it moves downstream from the die orifice. An air filtering device provided an annular air inlet orifice disposed axially between the die orifice and the annular cooling air outlet means so as to face towards the exterior of the tubular bubble as it was being formed. The inlet orifice was inter-connectable to vacuum creator for removing contaminants from the exterior of the tubular bubble.

With the use of that apparatus, a significant percentage of contaminants, e.g., smoke, odorous fumes and other airborne contaminants resulting from the extrusion process, are removed by a vacuum process immediately when the bubble emerges from the die orifice. That apparatus preferably had an annular chamber forming part of the filtering device, the annular chamber being connected to the inlet orifice by air passage means which is preferably a disc-shaped passage.

It was a significant feature of the prior art, including the above-identified co-pending application, that the air exited the lips either straight out to impinge upon the bubble, or was directed upwardly to follow the path of the bubble. It was never directed downwardly, both in the single lip air rings, as well as in the dual lip air rings. It was generally considered that if the air were to be directed downwardly, then the air would cool the die surface. This would interrupt the heating process, which was so important to the procedure. It was also generally considered that the primary air ring was always mounted over the die with a close proximity to the die surface.

Movement of the primary air ring, after start-up had never been considered normal and would be considered only for special applications.

In the prior art, the dual lip air ring divided the primary air stream into two streams by way of a device called a forming cone, fence or gate. This could be referred to as a minor flow of air and a major flow of air. The upper or major flow of air was the most aggressive and it served two distinctive purposes. This air had the greatest affect on the cooling. The high-speed air created a Venturi to lock the bubble close to the top of the forming cone. This improved the point-to-point tolerance variation.

The lower or minor airflow was diverted to the lower part of the air ring. It was closest to the die, and it was much lower in volume and velocity. This air was always directed upwardly and was used to premature the cooling or to reduce the temperature somewhat. It prepared the surface of the film for the higher velocity of air, from the major flow. This air passage was always directed upwardly and was located as close as possible to the die exit. Sometimes this air was introduced below the die surface.

### SUMMARY OF THE INVENTION

(a) Aims of the Invention

A first object of the present invention is to improve the above-described air cooling ring and method of cooling in order to increase the extrusion rate.

A second object of the present invention is to improve the lay-flat uniformity.

An third object of a the present invention is to improve gauge control.

A fourth object of a the present invention is to improve the film optics.

A fifth object of a fifth aspect of the present invention is to improve the film strength.

A sixth object of the present invention is to improve the extrusion rate with heavy gauge films.

A seventh object of the present invention is to cool the outside of the tube faster to increase extrusion rate without significantly affecting quality.

(b) Statements of Invention

The present invention provides an air ring structure, having a die axis, for supplying successive streams of cooling air to a surface of a tubular bubble of plastic, after its extrusion from an annular die surface. The air ring includes a ring-shaped plenum chamber including an air ring provided with an upper lip and with an air passage between upper and lower portions of thereof, and a lower deflector lip. The ring-shaped plenum chamber is provided radially-outwardly of the die axis from the annular die orifice and such plenum chamber has an air inlet. A forming cone is provided radially-outwardly of the air ring. A plurality of axial outlet ports is provided in an annular air passage within the forming cone which communicates with the air inlet in the ring-shaped plenum chamber. Annular air inlet means communicate with the plurality of axial outlet ports to direct cooling air downwardly and radially-outwardly to a lower annular air outlet, and then to divert the cooling air both in an upward direction between an outer conical surface of the forming cone and the inner surface of the tubular bubble of plastic, and radially-inwardly between the lower portion of the upper lip of the ring and the deflector lip.

The present invention also provides air ring structure, having a die axis, for supplying successive streams of cooling air to a surface of a tubular bubble of plastic, after its extrusion from an annular die surface. The air ring structure includes a ring-shaped plenum chamber including an air ring provided with an upper lip and with an air passage between upper and lower portions of thereof and a lower deflector lip. The ring-shaped plenum chamber is provided radially-outwardly of the die axis from the annular die orifice and such plenum chamber has an air inlet. A forming cone is provided radially-outwardly of the air ring. A plurality of axial outlet ports provided in an annular air passage within the forming cone which communicates with the air inlet means in the ring-shaped plenum chamber. A first annular air inlet communicates with the plurality of axial outlet ports to direct cooling air downwardly and radially-outwardly to a lower annular air outlet and then to divert the cooling air both in an upward direction between an upper conical surface of the forming cone and the tubular bubble of plastic, and radially-inwardly between the lower portion of the upper lip of the ring and the deflector lip. A second annular air outlet communicates with the air inlet and is disposed radially-outwardly of the air ring. Such second annular air outlet is directed upwardly and outwardly towards the path of the tubular bubble, in contact with a conical surface of the forming cone and the inner surface of the tubular bubble.

The present invention further provides apparatus for extruding a tubular plastic bubble. The apparatus includes a plastic extruder having an annular orifice surrounding a die axis and a cooling air inlet. The apparatus includes an air ring structure for supplying successive streams of cooling air to a surface of a tubular bubble of plastic, after its extrusion from an annular die surface. The air ring structure includes a ring-shaped plenum chamber which is provided radially-outwardly of the die axis from the annular die orifice. The ring-shaped plenum chamber includes an air ring provided with an inlet and an air outlet, as well as an upper lip and with an air passage between upper and lower portions of thereof and a lower deflector lip. A forming cone is provided radially-outwardly from the air ring. The forming cone includes an annular air passage which communicates with the air outlet of the ring-shaped plenum chamber. A plurality of axial outlet ports is provided in the annular air passage within the forming cone. An annular air inlet communicates with the plurality of axial outlet ports to direct cooling air downwardly and radially-outwardly to a lower annular air outlet, and then to divert the cooling air both in an upward direction between an outer conical surface of the forming cone and the inner surface of the tubular bubble of plastic, and radially-inwardly between the portion of the upper lip of the ring and the deflector lip.

The present invention still further provides apparatus for extruding a tubular plastic bubble. The apparatus includes a plastic extruder having an annular orifice surrounding a die axis and an air cooling ring for supplying successive streams of cooling air to a surface of a tubular bubble of plastic, after its extrusion from an annular die surface. A ring-shaped plenum chamber is provided radially-outwardly of the die axis from the annular die orifice and such plenum chamber has an air inlet. The ring-shaped plenum chamber includes an upper lip and with a lower deflector lip. A forming cone is provided radially-outwardly from the air cooling ring and with an annular air passage within the forming cone which communicates with the air inlet in the ring-shaped plenum chamber. A plurality of axial outlet ports is provided in the annular passage. A first annular air outlet communicates with the plurality of axial outlet ports to direct cooling air downwardly and radially-outwardly to a lower annular air outlet and then to divert the cooling air both in an upward direction between an outer conical surface of the forming cone and an inner surface of the tubular bubble of plastic, and radially-inwardly between the upper lip of the ring and the deflector lip. A second annular air outlet communicates with the air inlet and is disposed radially-outwardly of the air ring. Such second annular air outlet is directed upwardly and outwardly towards the path of the tubular bubble, in contact with an inner surface of the forming cone and an inner surface of the tubular bubble.

The present invention also provides a method for supplying successive streams of cooling air to an inner surface of a tubular bubble of plastic, after its extrusion from an annular die surface, the annular die surface having a die axis. The method includes the steps of providing a ring-shaped plenum chamber radially-outwardly of the die axis from said annular die orifice, and providing an air inlet into the ring-shaped plenum chamber. The ring-shaped plenum chamber is provided with an upper lip which is formed with the air inlet, and with a lower deflector lip. A forming cone is provided radially-outwardly of the air ring-shaped plenum chamber. An annular air passage is provided within the forming cone. A plurality of radial outlet ports is provided in annular air passage to communicate with the air inlet in the ring-shaped plenum chamber. An annular air inlet communicates with the axial outlet ports. Cooling air, is directed by means of the annular air inlet, downwardly and radially-outwardly to a lower annular air outlet. The cooling air is then directed both in an upward direction between a conical inner surface of the forming cone and an outer surface of the tubular bubble of plastic, and radially-inwardly between the upper lip of ring and the deflector lip.

The present invention yet further provides a method for supplying successive streams of cooling air to a surface of a tubular bubble of plastic, after its extrusion from an annular die surface, the annular die surface having a die axis. The method includes providing a ring-shaped plenum chamber radially-outwardly of the die axis from said annular die orifice; and providing an air inlet into the ring-shaped plenum chamber. The ring-shaped plenum chamber is provided with an upper lip which is formed with the air inlet means, and with a lower deflector lip. A forming cone is provided radially-outwardly of the air ring-shaped plenum chamber. An annular air passage is provided within the forming cone. A plurality of radial outlet ports is provided in the annular air passage to communicate with the air inlet in the ring-shaped plenum chamber. An annular air inlet communication is provided with the axial outlet ports. A first stream of cooling air is directed by means of the annular air inlet means, downwardly and radially-outwardly to a lower annular air outlet and then the cooling air is diverted both in an upward direction between a conical outer surface of the forming cone and an inner surface of the tubular bubble of plastic, and radially-inwardly between said upper lip of said ring and the deflector lip. A second annular outlet communicates with the air outlet. A second stream of cooling air is directed, by means of the second annular air outlet radially-outwardly of the upper lip towards the path of the tubular bubble, in contact with a conical surface of the forming cone and an outer surface of said tubular bubble.

(c) Other Features of the Invention

By a first feature of the air ring structures of this invention, the air ring structure is one wherein the upper lip is configured to be vertically movable, both upwardly and downwardly.

By a second feature of the air ring structures of this invention, the forming cone includes a lower inner surface comprising a first inner disc merging into a first downward and outward conical surface, which merges into a second downward and outward conical surface terminating at the lower annular air outlet. By a first subsidiary feature of this second feature of the air ring structure of the invention, the air cooling ring includes a second inner disc, which is vertically spaced-apart from the first inner disc, to define the lower air outlet therebetween. By a second subsidiary feature of this second feature of the air ring structure of the invention, the second inner disc mergers into a first upper inner conical surface, which merges into a second upper conical surface which terminates at an upper annular air outlet. By other subsidiary features of these air ring structures of this invention, the upper lip is vertically-movable by electrically operated means, or by hydraulically-operated means, or by pneumatically-operated means, or by manually-operated means.

By a third feature of the two extruding apparatus of this invention, the deflector lip is configured to be vertically movable, both upwardly and downwardly.

### BRIEF DESCRIPTION OF THE DRAWINGS

In the accompanying drawings,

FIG. 1 is a central vertical half section through the air cooling ring according to a first embodiment for plastic film and in association of this invention with a portion of an extrusion die including a depiction of the air flow;

FIG. 2 is an enlarged view of a portion of FIG. 1, showing air flow; and

FIG. 3 is an enlarged view of a second embodiment of this invention.

### DESCRIPTION OF PREFERRED EMBODIMENTS

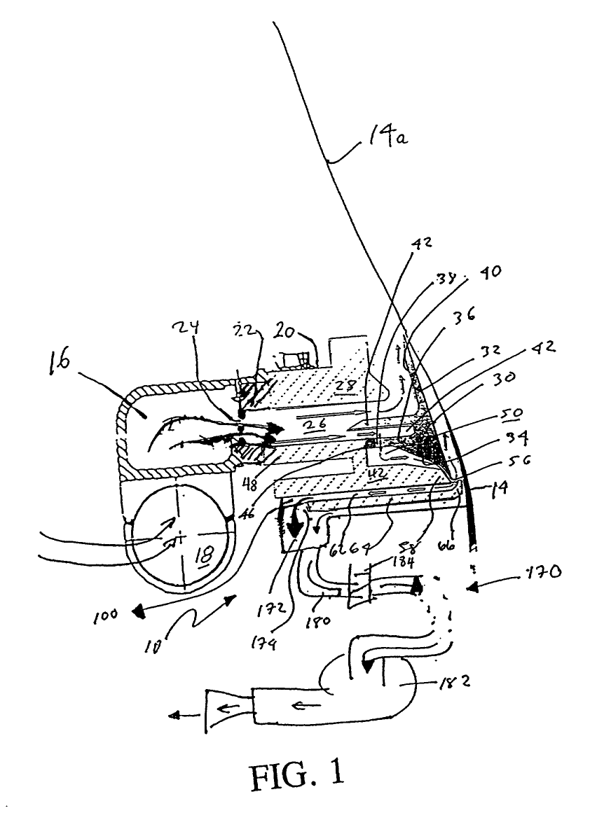

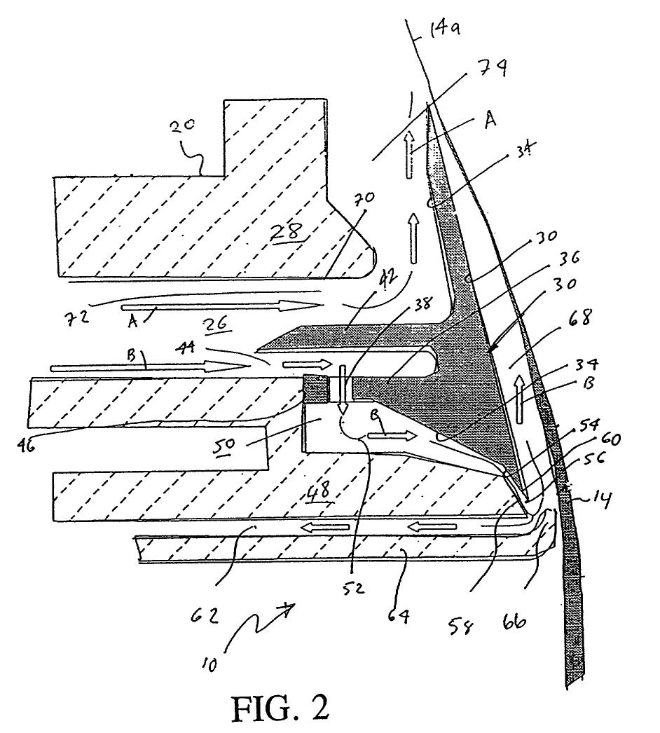

(a) Description of FIG. 1 and FIG. 2

FIGS. 1 and 2 show an air ring means, generally indicated as item 10, in its operative position above an extrusion die which is mounted on top of a plastics extruder of well-known structure and shown, for example, in the above-identified copending application, the entire contents of which are incorporated herein by reference. Item 10 is, in effect, the die or nozzle from which the polymer is extruded.

The extruder includes in an annular nozzle on an outwardly/upwardly facing shoulder set at about 45 degrees to the axis of the extruder die. The nozzle produces a thin-walled cone of synthetic plastic material, i.e., polymeric material, which is expanded to form an expanding tubular bubble 14 by air which is injected into the tube through the centre of the nozzle, while the bubble is drawn upwardly by nip rollers (not shown). As the bubble moves upwardly and cools, the expanded bubble 14a so formed is then supported by a so-called “cooling can” located by a centering device held at the centre of the die as the bubble moves along the can towards the nip rollers. The nozzle, central air supply and “cooling can” are all of known form and do not constitute part of the invention.

The air ring means 10 is, in effect, the die or nozzle from which the polymer is extruded surrounded by an air plenum chamber 16 supplied with air through inlet ducts 18. The plenum chamber 16 is divided from air cooling ring 20 by a connecting member 22. Connecting member 22 includes a plurality of air outlet apertures 24 leading to a primary passage 26 between the upper lip 28 and an upper part of the lower lip 42 of the air ring 20.

The air ring 20 is provided, at its outer peripheral edges, with a forming cone 30. Forming cone 30 includes an conical outer surface 32, and a lower inner conical surface 34 which extends upwardly and inwardly to terminate in a lower disc-like ledge 36, which is provided with a plurality of circumferentially-spaced-apart air outlets 38. An upper, inner, conical surface 40 extends downwardly and inwardly to terminate in an upper, disc-like ledge 42. Ledge 42 is spaced-apart from ledge 36 to provide an annular air passage 44 therebetween.

It will be noted that the forming cone 30 is secured to an outer cylindrical wall 46 of the lower portion 48 of the upper lip 28 of the air ring 20. In addition, outer cylindrical wall 46 forms the inner limit of an air chamber 50, which includes an annular inner portion 52 leading to an outwardly and downwardly sloping sluice 54 which terminates at an air outlet 56 which is formed at the confluence of the lower circumferential edge 58 of the lower portion 48 of the upper lip 28, and the lower circumferential edge 60 of the forming cone 30.

The lower portion 48 of the upper lip 28 of the air ring 20 is spaced-apart by an air channel 62 from a lower deflector lip 64. Lower deflector lip 64 includes a circumferential edge which is upturned at 66, to provide lower horizontal air channel 62 as well as inclined cooling channel 68.

The air ring 20 also includes an upper lip 70. Upper lip 70 is configured to provide a major horizontal air passage 72 between the upper lip 70 and the ledge 42, as well as a vertical air channel 74.

FIG. 1 also shows an optional add-on air withdrawal system. The outlet air exiting from the horizontal air channel 61 is withdrawn through a withdrawal system as shown. Such air withdrawal system can be a single air removal through a chamber, conduits and withdrawal pump, or it may be provided with an air filtering device 170.

This air filtering device has a cylindrical vacuum chamber 172 which is connected via channel 176 which faces towards the path of the polymeric material immediately as it issues from the extrusion orifice. The channel 176 is an inlet orifice for removing contaminants, e.g., smoke, odorous fumes, and other airborne contaminants exiting the extrusion orifice as a result of the extrusion process.

The vacuum chamber 172 is connected via vacuum tubes 180 to a vacuum creating means in the form of an electrically driven blower 182. Filters are provided as necessary throughout the air filtering device. In this embodiment, a filter may be provided, for instance, as an annular filter 184 within the passageway 180. This filter may be easily removable.

The air filtering device may be secured directly to the air ring means 20. Immediately when contaminants issue from the horizontal air channel 62, they are removed through the vacuum cylinder 172. The filter operates to extract contaminants which may be harmful to personnel. The air which has been cleaned by the filters may then be discharged into the surrounding air within the factory if desired.

It is also important to note that with the inlet positioned closely adjacent to the die orifice, a certain quantity of heat will immediately be removed from the tube as it exits the die orifice. The inlet 174, provides a unique feature in that some of the cooling air from the cooling air outlet 56 is drawn by the inlet 174 upstream of the flow of the tubular bubble thereby providing an initial cooling effect upon the plastic as it emerges from the die orifice. Immediate removal of heat in this manner reduces the amount of radiant heat emitted into a factory environment thereby enabling better factory temperature control. The removal of the contaminants presents a healthier working environment and assists in retarding the accumulation of undesirable debris and contaminant surface coatings upon factory structures and machines.

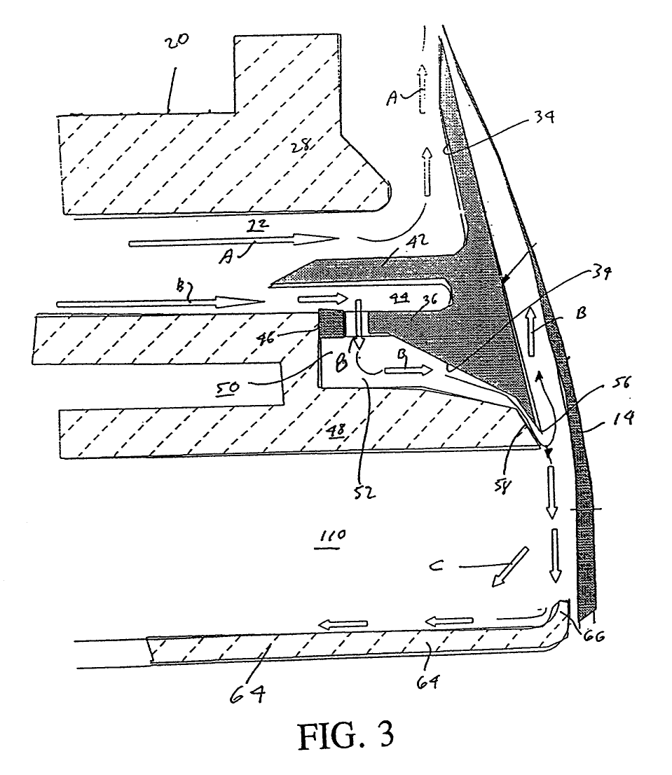

(b) Description of FIG. 3

FIG. 3 shows another embodiment of the present invention which is generally similar to the embodiment of FIG. 2. Where identical parts exist, they will not be described further.

The major change is to provide an elevator (not shown) to raise the air ring 20 so as to provide larger air outlet chamber 110 between the lower portion 48 of the upper lip of the air ring 20, and the deflector lip 64. The purpose of this change is to increase the downwardly-directed air flow (as seen by arrows C). This provides a better cooling effect on the bubble stock.

It will be noted that the lower lip 48 is fixed to the die. This serves the purpose of protecting the die surface from being cooled down by the introduction of air. It directs the air radially-outwardly and discharges the air. This downward airflow shown by arrows B and C is also aggressive.

The height of the upward movement of the air ring could be from ⅛ of an inch to 10 times the diameter of the die or in between. The height will depend on the material being run, e.g., blow-up ratio, film thickness, and temperature of the stock and the internal pressure of the bubble. Moving of the elevator can be electric, hydraulic, pneumatic or manual.

The plate which is mounted on the die surface can be made of almost any material or combination of materials. There could be an air-gap between the die and the deflector plate. An insulating material could be used to mount the plate directly on the surface of the die.

(c) Operation of the Invention

In operation of the embodiment shown in FIG. 1 and FIG. 2, air is supplied to the plenum chamber 16 while synthetic plastic material is extruded as extrudant 14 from the nozzle. The synthetic plastic material leaves the nozzle as a cone with an angle of divergence of 45 degrees from the die axis. Cooling air takes two distinct paths due to the novel construction of the outside bubble air cooling structure of an embodiment of this invention. One flow path of air follows the path of arrows “A” (see FIGS. 2 and 3) from the major air passage 72 to the vertical air channel 74 to flow along the inner conical surface 34 of the forming cone 30, eventually to come into cooling contact with the outer surface of the extruded bubble 14 to form a cooled bubble 14a. A second flow path of air follows arrows “B”, i.e., from major air passage 72 into annular air passage 44, then downwardly through air outlets 38, then into air chamber 50 to flow out through air outlet 56. At air outlet 56, the cooling air splits into two slow paths to flow through inclined cooling channel 68, where it contacts the inner surface of the newly-extruded polymer 14, to flow upwardly to merge with the first airflow, and through horizontal air channel 68 to be withdrawn. Air may be discharged directly to ambient at 100.

### CONCLUSION

From the foregoing description, one skilled in the art can easily ascertain the essential characteristics of this invention, and without departing from the spirit and scope thereof, can make various changes and modifications of the invention to adapt it to various usages and conditions. Consequently, such changes and modifications are properly, equitably, and “intended” to be, within the full range of equivalence of the following claims.

I claim:

1. An air cooling ring for supplying successive streams of cooling air to a surface of a tubular bubble of plastic, after its extrusion from an annular die surface, said annular die surface having a die axis, said air cooling ring comprising:
a ring-shaped plenum chamber which is provided radially-outwardly of said die axis from said annular die orifice, said ring-shaped plenum chamber having an air inlet and an air outlet, said ring-shaped plenum chamber including an upper lip which encompasses said air inlet, and a lower deflector lip;
a forming cone extending radially-outwardly from said air cooling ring, said forming cone including an air passage which communicates with said air outlet of said ring-shaped plenum chamber;
a plurality of axial outlet ports communicating with said air passage;
an annular air chamber communicating with said plurality of axial outlet ports; and
a lower annular air outlet at the base of said forming cone;
whereby:
cooling air is directed downwardly and radially-outwardly to be discharged out of said lower annular air outlet, and then to be diverted into two paths, a first path being in an upward direction between an outer conical surface of said forming cone and an outer surface of said tubular bubble of plastic, a second path being in a direction radially-and-horizontally-inwardly between said upper lip of said lower portion of said air cooling ring and said deflector lip.

2. An air cooling ring for supplying successive streams of cooling air to a surface of a tubular bubble of plastic, after its extrusion from an annular die surface, said annular die surface having a die axis, said air cooling ring comprising:
a ring-shaped plenum chamber which is provided radially-outwardly of said die axis from said annular die orifice, said ring-shaped plenum chamber having an air inlet and upper and lower air outlet, said ring-shaped plenum chamber including an upper lip which encompasses said air inlet, and a lower deflector lip;
a forming cone extending radially-outwardly from said air cooling ring, said forming cone including an air passage which communicates with said lower air outlet of said ring-shaped plenum chamber, and providing a divider between said upper and lower air outlet;
a plurality of axial outlet ports communicating with said air passage;
an annular air chamber communicating with said plurality of axial outlet ports; and
a lower annular air outlet at the base of said forming cone;
whereby:
cooling air from said lower air outlet is directed downwardly and radially-outwardly to be discharged out of said lower annular air outlet, and then to be diverted into two paths, a first path being in an upward direction between an outer conical surface of said forming cone and an outer surface of said tubular bubble of plastic, a second path being in a direction radially-and horizontally-inwardly between said upper lip of the lower portion of said air cooling ring and said deflector lip; and
cooling air from said upper air outlet means is directed upwardly in contact with an inner upper conical surface of said forming cone and then to contact an outer surface of said tubular bubble of plastic.

3. The air cooling ring means of claim 1, wherein said upper lip is configured to be vertically movable, both upwardly and downwardly.

4. The air cooling ring means of claim 2, wherein said upper lip is configured to be vertically movable, both upwardly and downwardly.

5. The air cooling of claim 1, wherein said forming cone includes a lower inner surface comprising a first inner disc merging into a first downward and outward conical surface, which merges into a second downward and outward conical surface terminating at said lower annular air outlet.

6. The air cooling ring of claim 5 including a second inner disc is vertically spaced-apart from said first inner disc, to define said lower air outlet means therebetween.

7. The air cooling ring of claim 6, wherein said second inner disc merges into a first upper inner conical surface which merges into a second upper conical surface which terminates at an upper annular air outlet.

8. The air cooling ring of claim 3, wherein said upper lip is vertically-movable by electrically operated means.

9. The air cooling ring of claim 4, wherein said upper lip is vertically-movable by electrically operated means.

10. The air cooling ring of claim 3, wherein said upper lip is vertically-movable by hydraulically-operated means.

11. The air cooling ring of claim 4, wherein said upper lip is vertically-movable by hydraulically-operated means.

12. The air cooling ring of claim 3, wherein said upper lip is vertically-movable by pneumatically-operated means.

13. The air cooling ring of claim 4, wherein said upper lip is vertically-movable by pneumatically-operated means.

14. The air cooling ring of claim 3, wherein said upper lip is vertically-movable by manually-operated means.

15. The air cooling ring of claim 4, wherein said upper lip is vertically-movable by manually-operated means.

16. Apparatus for extruding a tubular plastic bubble comprising:
a plastic extruder having an annular die orifice and having a cooling air inlet; and
an air cooling ring, said air cooling ring comprising:
a ring-shaped plenum chamber which is provided radially-outwardly of said die axis from said annular die orifice, said ring-shaped plenum chamber having an air inlet and an air outlet, said ring-shaped plenum chamber including an upper lip which encompasses said air inlet, and a lower deflector lip;
a forming cone extending radially-outwardly from said air cooling ring, said forming cone including an air passage which communicates with said air outlet of said ring-shaped plenum chamber;
a plurality of axial outlet ports communicating with said air passage;
an annular air chamber communicating with said plurality of axial outlet ports; and
a lower annular air outlet at the base of said forming cone;
whereby:
cooling air is directed downwardly and radially-outwardly to be discharged out of said lower annular air outlet, and then to be diverted into two paths, a first path being in an upward direction between a conical surface of said forming cone and an outer surface of said tubular bubble of plastic, a second path being in a direction radially-and-horizontally-inwardly between said upper lip of the lower portion of said air cooling ring and said deflector lip.

17. Apparatus for extruding a tubular plastic bubble comprising:
a plastic extruder having an annular orifice surrounding a die axis and having a cooling air inlet; and
an air cooling ring, said air cooling ring comprising:
a ring-shaped plenum chamber which is provided radially-outwardly of said die axis from said annular die orifice, said ring-shaped plenum chamber having an air inlet and upper and lower air outlets, said ring-shaped plenum chamber including an upper lip which encompasses said air inlet, and a lower deflector lip;
a forming cone extending radially-outwardly from said air cooling ring, said forming cone including an air passage which communicates with said lower air outlet of said ring-shaped plenum chamber, and providing a divider between said upper and lower air outlets;
a plurality of axial outlet ports communicating with said air passage;
an annular air chamber communicating with said plurality of axial outlet ports; and
a lower annular air outlet at the base of said forming cone;
whereby:
cooling air from said lower air outlet is directed downwardly and radially-outwardly to be discharged out of said lower annular air outlet, and then to be diverted into two paths, a first path being in an upward direction between a conical surface of said forming cone and an outer surface of said tubular bubble of plastic, a second path being in a direction radially-and horizontally-inwardly between said upper lip of the lower portion of said air cooling ring and said deflector lip; and
cooling air from said upper air outlet is directed upwardly in contact with an inner upper conical surface of said forming cone and then to contact an outer surface of said tubular bubble of plastic.

18. The apparatus of claim 16, wherein said upper lip is configured to be vertically movable, both upwardly and downwardly.

19. The apparatus of claim 17, wherein said upper lip is configured to be vertically movable, both upwardly and downwardly.

20. The apparatus of claim 16, wherein said forming cone includes a lower inner surface comprising a first inner disc merging into a first downward and outward conical surface which merges into a second downward and outward conical surface terminating at said lower annular air outlet.

21. The apparatus of claim 20, wherein said air cooling ring of claim 4 including a second inner disc vertically spaced-apart from said first inner disc, to define said lower air outlet means therebetween.

22. The apparatus of claim 21, wherein said second inner disc merges into a first upper inner conical surface which merges into a second upper conical surface which terminates at an upper annular air outlet.

23. A method for supplying successive streams of cooling air to an inner surface of a tubular bubble of plastic, after its extrusion from an annular die surface, said annular die surface having a die axis, said method comprising:
providing a ring-shaped plenum chamber radially-outwardly of said die axis from said annular die orifice;
providing an air inlet into said ring-shaped plenum chamber;
providing said ring-shaped plenum chamber with an upper lip which is formed with said air inlet, and with a lower deflector lip;
providing a forming cone radially-outwardly of said air ring-shaped plenum chamber;
providing an annular air passage within said forming cone;
providing a plurality of radial outlet ports in said annular air passage to communicate with said air inlet in said ring-shaped plenum chamber;
providing an annular air outlet communicating with said axial outlet ports;
directing cooling air, by means of said annular air outlet, downwardly and radially-outwardly to a lower annular air outlet; and
then diverting said cooling air both in an upward direction between a conical inner surface of said forming cone and an outer surface of said tubular bubble of plastic, and radially-inwardly between said upper lip of said ring and said deflector lip.

24. A method for supplying successive streams of cooling air to a surface of a tubular bubble of plastic, after its extrusion from an annular die surface, said annular die surface having a die axis, said air method comprising:
providing a ring-shaped plenum chamber radially-outwardly of said die axis from said annular die orifice;
providing an air inlet into said ring-shaped plenum chamber;
providing said ring-shaped plenum chamber with an upper lip which is formed with said air inlet, and with a lower deflector lip;
providing a forming cone radially-outwardly of said air ring-shaped plenum chamber;
providing an annular air passage within said forming cone;
providing a plurality of radial outlet ports in said annular air passage to communicate with said air inlet in said ring-shaped plenum chamber;
providing a first annular air communication with said axial outlet ports;
providing a second annular inner outlet means communicating with said air outlet;
directing cooling air, by means of said first annular air inlet downwardly and radially-outwardly to a lower annular air outlet and then diverting said cooling air both in an upward direction between a conical outer surface of said forming cone and an inner surface of said tubular bubble of plastic, and radially-inwardly between said upper lip of said ring and said deflector lip; and
directing a second stream of cooling air by means of said second annular air outlet means radially-outwardly of said upper lip towards the path of said tubular bubble, in contact with a conical surface of said forming cone and an outer surface of said tubular bubble.
